(19) United States
(12) Patent Application Publication
(10) Pub. No.: US 2007/0104821 A1
(43) Pub. Date: May 10, 2007

(54) Machine and method for molding articles made of loose material, for manufacturing loading pallet stringers

(75) Inventor: Paolo Benedetti, Frazione SAN DAMASO (IT)

Correspondence Address: MODIANO & ASSOCIATI, Via Meravigli, 16, Milan, 20123, IT

(73) Assignee: IMAL S.R.L.

(21) Appl. No.: 11/356,974

(22) Filed: Feb. 21, 2006

(30) Foreign Application Priority Data
Nov. 4, 2005 (IT) MO2005A000291

(51) Int. Cl. B29C 49/00

(52) U.S. Cl. 425/522

(57) ABSTRACT

A machine for molding articles made of loose material, particularly for manufacturing stringers for loading pallets, comprising an upper mold part and a lower mold part, which can be moved with respect to each other along a substantially vertical direction and can be mutually superimposed, with the interposition of a loose material, in order to mold at least one article. At least one molding element, which is associated slidingly with the upper mold part or the lower mold part or both is further provided and is adapted to shape at least one portion of the article.

The present invention relates to a machine for molding articles made of loose material, particularly for manufacturing stringers for loading pallets.

### BACKGROUND OF THE INVENTION

It is known that loading pallets are implements which are generally made of wood and are widely employed to form transportable loading units of various goods, such as for example finished products, intermediate components, or the like.

Conventionally, each pallet is constituted by a loading platform, which is quadrangular and is constituted generally by a plurality of boards arranged so that they are mutually parallel and coplanar, and is supported by a footing which is variously shaped depending on the type of application of the pallet.

The footing can be constituted by supporting cross-members, commonly known as stringers, of which two are fixed at two mutually opposite sides of the platform and one is fixed at the centerline of such platform, the stringers being mutually parallel so as to delimit two seats which are adapted for the insertion of the forks of the lift trucks used to handle the pallets.

In the case of four-way pallets, each of the stringers is further provided with two recesses, which are adapted to form additional seats for the insertion of the forks of lift trucks, which are substantially transverse with respect to the above-mentioned seats and ensure the possibility to load the pallet from each one of its sides.

It is known to use machines adapted to produce stringers by pressing loose wood-based material (with the optional addition of binders).

These machines generally comprise a substantially elongated container provided with an upper opening. A pressing plate is arranged in an upper region with respect to the container and can perform a translational motion along a substantially vertical axis from an inactive position, in which the plate lies outside the container, to an active position, in which the plate is inserted within the container, through such opening.

The plate is shaped conventionally so as to form two mutually spaced protruding portions, which extend from the mold toward the container.

A preset amount of loose material, in the form of powder or chips, is moved toward the press. The plate moves downward and the pressing action on the material, together with the optional action of heating means (for example by introducing steam), allows to obtain a compact block which is molded so as to provide a stringer.

The particular shape of the container and of the press give the stringer the appropriate elongated shape, and the presence of the protrusions allows to form the substantially concave portions of the stringer.

These known machines are not free from drawbacks, including the fact that the pressing thus performed provides higher compression at the protruding portions of the plate, leading to a final product whose quality is not high as regards uneven density along its entire extension.

Moreover, if one wishes to manufacture stringers having different shapes and dimensions, it is necessary to replace the plate completely, with substantial machine setup times and with a consequent increase in general production costs.

### SUMMARY OF THE INVENTION

The aim of the present invention is to eliminate the above-mentioned drawbacks of the background art, by providing a machine for molding articles made of pressed loose material which allows to manufacture stringers for loading pallets, while ensuring high productivity and relatively high quality of the resulting stringers.

An object of the present invention is to allow the molding of stringers having a different shape while minimizing the corresponding setup times of the machine.

Another object of the present invention is to ensure a quick production cycle, with a consequent reduction of general production costs.

Within this aim, a further object of the present invention is to provide a structure which is simple, relatively easy to provide in practice, safe in use, effective in operation, and has a relatively low cost.

This aim and these and other objects that will become better apparent hereinafter are achieved by the present machine for molding articles made of loose material, particularly for manufacturing stringers for loading pallets, comprising an upper mold part and a lower mold part, which can be moved with respect to each other along a substantially vertical direction and can be mutually superimposed, with the interposition of a loose material, in order to mold at least one article, characterized in that it comprises at least one molding element, which is associated slidingly with the upper mold part or the lower mold part or both and is adapted to shape at least one portion of the article.

### BRIEF DESCRIPTION OF THE DRAWINGS

Further characteristics and advantages of the present invention will become better apparent from the following detailed description of a preferred but not exclusive embodiment of a machine for molding articles made of loose material, particularly for manufacturing stringers for loading pallets, illustrated by way of non-limiting example in the accompanying drawings, wherein:

FIG. 1 is a schematic sectional front view of the machine according to the invention in an inactive configuration;

FIGS. 2 and 3 are schematic sectional front views of the machine according to the invention in two different configurations during the pressing step;

FIG. 4 is a perspective view of a stringer manufactured by means of the machine according to the invention;

FIG. 5 is a perspective view of a loading pallet.

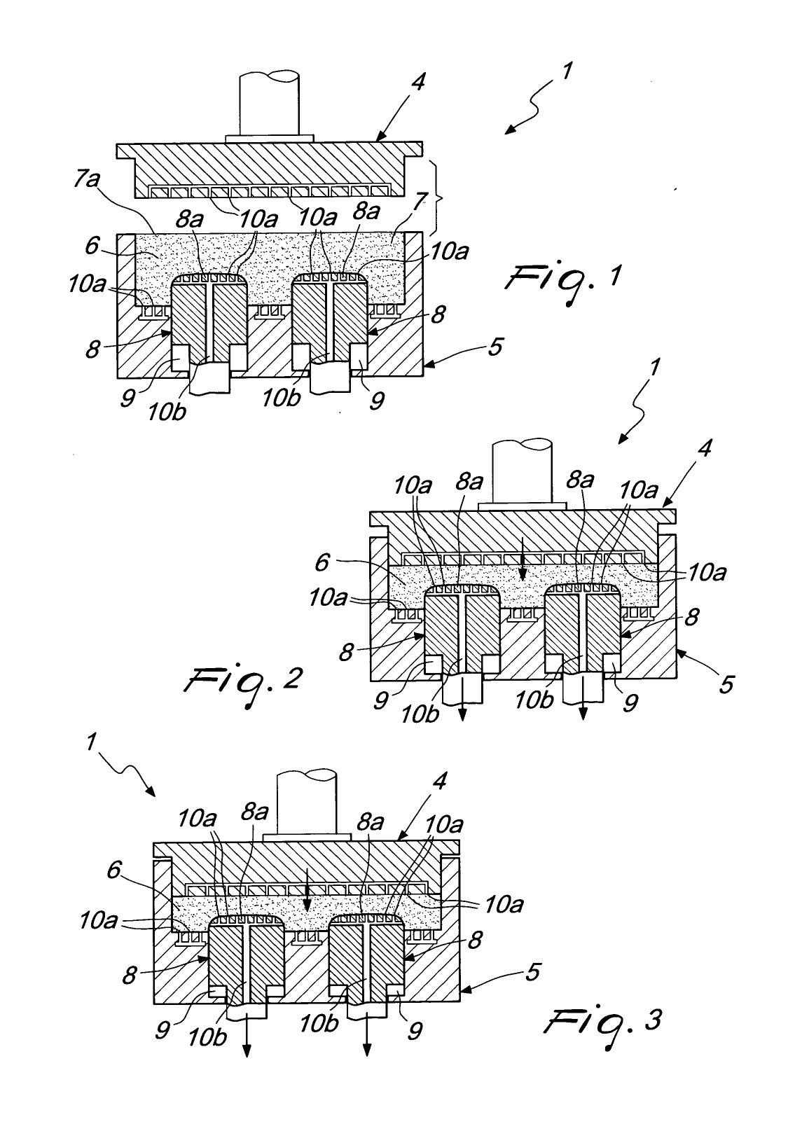

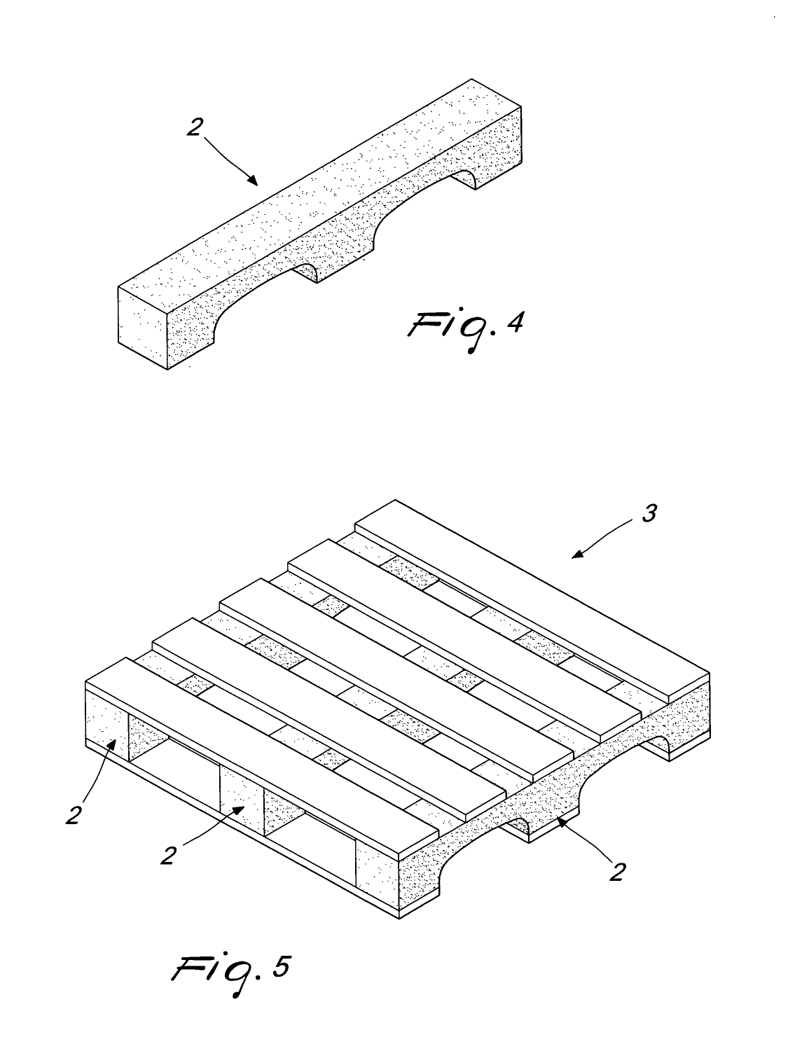

### DESCRIPTION OF THE PREFERRED EMBODIMENTS

With reference to the figures, the reference numeral 1 generally designates a machine for molding articles made of pressed loose material.

Specifically, the manufactured article 2 is constituted by a cross-member, shown in FIG. 4, which is used for loading pallets 3 generally used in the field of transport and conveyance of goods and is known conventionally as stringer.

The machine 1 comprises an upper mold part 4 and a lower mold part 5, which can be moved mutually closer and superimposed, with the interposition of loose material 6, in order to mold the stringer 2.

In particular, the loose material 6 can be moved at the lower mold part 5, in the state of a continuous stream of a substantially uniform material, in the form of powder or chips, by way of a conventional feeder line, such as a conveyor belt or the like.

The optional addition of binders to the loose material 6 facilitates its setting during the pressing operation.

As an alternative, the loose material 6 can be of the type of panels of pre-pressed material, which can be positioned individually between the upper mold part 4 and the lower mold part 5 by way of a feeder line or a loading station.

Conveniently, the lower mold part 5 comprises a chamber 7 for collecting the loose material 6 which is provided with an upper opening 7a and is arranged below the upper mold part 4.

The upper mold part 4 is substantially plate-like and can move along a substantially vertical direction of translational motion for the opening and closing of the collection chamber 7.

In particular, the upper mold part 4 can slide from an inactive position, in which the upper mold part 4 is spaced substantially with respect to the collection chamber 7, to an active position, in which the upper mold part 4 is inserted at least partially within the collection chamber 7 and is adapted to press the loose material 6 contained therein.

The machine 1 further comprises two molding elements 8, which are substantially elongated and are inserted slidingly within respective openings 9, which are formed in the bottom of the collection chamber 7 and are adapted to form respective substantially concave portions of the stringer 2 during the molding operation.

In particular, the two molding elements 8 can move along a sliding direction which is substantially parallel to the direction of translational motion of the upper mold part 4 and are provided with respective heads 8a (which are for example rounded), which protrude at least partially from the respective openings 9 toward the upper mold part 4.

Means for actuating the two molding elements 8, not shown in the figures for the sake of greater clarity in illustration, can be actuated by the upper mold part for the translational motion, in cooperation, of the upper mold part 4 along the direction of translational motion and of the heads 8 along such sliding direction.

In particular, the expression “translational motion in cooperation” is understood to designate the translational motion of the upper mold part 4 from the inactive position to the active position and the simultaneous sliding of the molding elements 8 from a position which protrudes within the collection chamber 7 to a position which is retracted within the chamber, both positions being preset.

Advantageously, the machine 1 comprises means for introducing a first hot fluid, such as steam, into the collection chamber 7, which comprise a plurality of ports 10a for dispensing steam which are formed at the outer surface of the molding elements 8, at the internal surface of the collection chamber 7, and at the lower surface of the upper mold part 4.

With particular reference to the molding elements 8, the dispensing outlets 10a are formed within the heads 8a and extend from a single channel 10b for feeding the steam.

The steam is injected within the mass of loose material 6 introduced within the collection chamber 7 before and during the pressing step in order to act on such material and on any binders, so as to rapidly obtain a single compact and strong part, which forms the stringer 2.

The machine 1 further comprises suction means, which are adapted to produce a vacuum within the collection chamber 7 in order to recover the steam introduced during the pressing operation.

In particular, the suction means employ the same dispensing ports 10a and the same feed channels 10b used with reference to the injection means.

Conveniently, the machine 1 comprises means for heating the upper mold part 4, the lower mold part 5, and the two molding elements 8, which are constituted by respective internal hydraulic circuits, which are adapted to be crossed by a second hot fluid. The heating means are not shown in the figures, since they are of a type which is used conventionally.

In a manner similar to what has been described above with reference to the injection means, the heating means are adapted to facilitate the setting of the pressed loose material 6 and optionally the activation of the binders.

In practice it has been found that the described invention achieves the proposed aim and objects, and in particular the fact is stressed that the presence of the molding elements which can slide within the collection chamber allows to provide stringers which have a substantially uniform density along their entire extension, thus ensuring a high quality of the final product.

Moreover, it is noted that the possibility to vary the extension of the molding elements within the collection chamber allows to vary the dimensions of the recesses of the formed stringers, ensuring high flexibility of the machine while limiting the setup times of the machine.

Within this aim, another object of the present invention is to provide a structure which is simple, relatively easy to provide in practice, safe in use, effective in operation, and has a relatively low cost.

The invention thus conceived, is susceptible of numerous modifications and variations, all of which are within the scope of the appended claims.

All the details may further be replaced with other technically equivalent elements.

In practice, the materials used, as well as the shapes and dimensions, may be any according to requirements without thereby abandoning the scope of the protection of the appended claims.

The disclosures in Italian Patent Application No. MO2005A000291 from which this application claims priority are incorporated herein by reference.

What is claimed is:

1. A machine for molding articles made of loose material, for manufacturing stringers for loading pallets, comprising: an upper mold part; a lower mold part, said upper and lower mold parts being movable with respect to each other along a substantially vertical direction for being mutually superimposed, with interposition of a loose material, to mold at least one article; and at least one molding element, which is slidingly associated with one of said upper mold part, said lower mold part or with both of the upper and lower mold parts and is adapted to shape at least one portion of said article.

2. The machine of claim 1, wherein one of an upper face of the lower mold part or a lower face of the upper mold part, or both of said upper and lower faces, comprise at least one passage opening, in which said molding element is slidingly inserted.

3. The machine of claim 1, wherein said molding element is movable along a substantially vertical sliding direction.

4. The machine of claim 2, wherein said molding element comprises a head for shaping said article.

5. The machine of claim 1, wherein said molding element is associated with said lower mold part.

6. The machine of claim 4, wherein said lower mold part is provided with a collection chamber for collecting said loose material, said collection chamber being open upward and facing said upper mold part, said molding element being slidingly inserted within said collection chamber.

7. The machine of claim 6, wherein said collection chamber is provided with said passage opening.

8. The machine of claim 7, wherein said passage opening is formed at a bottom of said collection chamber.

9. The machine of claim 2, wherein one of the upper face of the lower mold part or the lower face of the upper mold part, or both said upper and lower faces, comprise a plurality of said passage openings.

10. The machine of claim 6, wherein said upper mold part is movable with respect to said lower mold part along a substantially vertical direction of translational motion in order to open and close said collection chamber.

11. The machine of claim 1, comprising actuation means for actuating said molding element in sliding motion.

12. The machine of claim 11, wherein said actuation means are actuatable by said upper mold part.

13. The machine of claim 6, comprising injection means for injecting a first hot fluid into said collection chamber.

14. The machine of claim 13, wherein said injection means are associated with at least one among said molding element, said upper mold part, and said lower mold part.

15. The machine of claim 14, wherein said injection means comprise at least one dispensing port for dispensing said first hot fluid, said port being formed at at least one among said molding element, the lower surface of said upper mold part, and an internal surface of said collection chamber.

16. The machine of claim 15, wherein said injection means comprise a plurality of said dispensing ports distributed on an external surface of said head.

17. The machine of claim 16, wherein said injection means comprise at least one duct for feeding said first hot fluid which is associated with a plurality of said dispensing ports.

18. The machine of claim 13, comprising suction means for aspirating said first fluid from said collection chamber.

19. The machine of claim 18, wherein said suction means comprise at least one suction opening, which is formed in at least one among said molding element, said lower mold part, and said upper mold part.

20. The machine of claim 1, comprising heating means for heating at least one among said upper mold part, said lower mold part and said two molding elements.

21. The machine of claim 20, wherein said heating means comprise at least one hydraulic circuit, which is adapted to be crossed by at least one second hot fluid.

22. A method for molding articles made of loose material, for manufacturing stringers for loading pallets, comprising:
moving at least one layer of loose material at a work area which is interposed between at least one upper mold part and one lower mold part, which are mutually spaced;
moving at least one molding element, which is slidingly associated with one of said upper mold part and said lower mold part, or with both said parts, to a preset protruding position, in which said molding element protrudes from said upper mold part toward said lower mold part, or vice versa;
moving said upper mold part and said lower mold part toward each other in order to press said loose material;
gradually retracting said molding element from said protruding position to a predefined retracted position, said retraction occurring simultaneously with said mutual approach.

23. The method of claim 22, wherein said loose material movement step comprises loading of said loose material into a collection chamber which is formed at said lower mold part, said collection chamber delimiting said work area.
